(19) United States
(12) Patent Application Publication
(10) Pub. No.: US 2015/0333533 A1
(43) Pub. Date: Nov. 19, 2015

(54) WIRELESS CHRISTMAS TREE LIGHTING AND ORNAMENTS DEVICE AND SYSTEM USING NON-RADIATIVE ENERGY TRANSFER

(71) Applicant: POWERED BY AURA, LLC, Fullerton, CA (US)

(72) Inventors: Christopher Thomas Higgins, Placentia, CA (US); Hardeep Singh Johar, Pasadena, CA (US); Joseph Craig Silva, Grand Terrace, CA (US)

(73) Assignee: POWERED BY AURA, LLC, Fullerton, CA (US)

(21) Appl. No.: 14/710,924

(22) Filed: May 13, 2015

Related U.S. Application Data
(60) Provisional application No. 61/992,229, filed on May 13, 2014.

(51) Int. Cl. H02J 5/00; H05B 37/00; F21V 23/02

(52) U.S. Cl. CPC H02J 5/005; F21V 23/026; H05B 37/00; F21W 2121/04

(57) ABSTRACT

A system is for wireless non-radiative energy transfer. A transmitter comprises an inductively coupled power source that is configured to provide a magnetic energy field. One or more receivers are configured to be placed within the magnetic energy field. A decoupling and rectifying stage is configured to supply power to a device.

### CROSS REFERENCE OF RELATED APPLICATIONS

The present application claims priority from U.S. Provisional Patent Application Ser. No. 61/992,229, entitled “WIRELESS CHRISTMAS TREE LIGHTING AND ORNAMENTS DEVICE AND SYSTEM USING NON-RADIATIVE ENERGY TRANSFER” filed on May 13, 2014, the contents of which are hereby incorporated by reference in its entirety.

### FIELD OF THE INVENTION

This invention generally relates to a wireless Christmas tree lighting and ornaments device and system using non-radiative energy transfer. More specifically, the invention provides a system and method that wirelessly transmits power to Christmas tree lights.

### BACKGROUND

Currently, Christmas trees and other similarly decorated trees and plants utilize wires to a power source or batteries whenever any accessories are used to decorate, monitor, or interact with the tree. This type of system uses either wires or batteries to power the accessories as those are the typical ways to provide power.

A single instance to a wireless Christmas tree does exist but it is fundamentally flawed and is not only dangerous if used with a large tree or a large amount of accessories. It utilizes radiating energy, which is destructive to human bodies if the body is in the direction of the field. Another disadvantage of this tree is that it also broadcasts uncontrolled wireless power signals in the direction the antenna sends the signals.

### SUMMARY OF THE INVENTION

In order to solve the problems and shortcomings of the prior art, according to one preferred embodiment, a system for wireless non-radiative energy transfer comprises: a transmitter comprising an inductively coupled power source that is configured to provide a magnetic energy field; one or more receivers that are configured to be placed within the magnetic energy field; and a decoupling and rectifying stage configured to supply power to a device.

### BRIEF DESCRIPTION OF THE DRAWINGS

FIG. 1 is a schematic diagram illustrating an exemplary embodiment of the energy source and device relationship;

FIG. 2 is a schematic diagram illustrating an exemplary embodiment of the energy source and its position with relation to a tree taken from an overhead view;

FIG. 3 is a schematic diagram demonstrating a variety of representative system configuration options taken from a side view if the tree were sliced vertically down the middle;

FIG. 4 is a schematic diagram demonstrating the interaction and representative attachment of the resonating element with the tree taken from an overhead view;

FIG. 5 is a flow diagram illustrates power flow through components of the system;

FIG. 6 is a circuit diagram of a repeater that could be used in one embodiment; and

FIG. 7 is a circuit diagram illustrates parts of a receiver that could be used according to one embodiment.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

The system and method described herein provides a wireless Christmas tree lighting and ornaments device and system using non-radiative energy transfer in accordance with preferred embodiments of the present invention and is illustrated in FIGS. 1-7 wherein like reference numerals are used throughout to designate like elements. With non-radiating energy, as utilized in the invention described herein, a system and method of inductive coupling is provided to power the accessories. An inductively coupled power source only provides power to the accessory or accessories within its field and only transmits the power required by the accessory or accessories whereas in the prior art radiating energy systems, the wireless power is transmitted without regard for the devices within its field and transmits power outward from the transmitter. A listing of the reference numerals follows:

102 a source resonating element

104 a receiving device

112 a tree circumference

121 a tree

122 a wire providing power

123 a powered source resonating element

124 a powered source resonating element

125 a powered source resonating element

131 a tree

132 a wire providing power

133 a powered source resonating element

134 an unpowered source resonating element

135 an unpowered source resonating element

141 a tree

142 a wire providing power

143 a powered source resonating element

144 an unpowered source resonating element

145 a powered source resonating element

151 a tree trunk

152 a source resonating element segment

153 a source resonating element segment

155 a tree trunk

156 a source resonating element segment

157 a source resonating element segment

FIG. 1 depicts a schematic diagram illustrating the relationship between a transmitting energy source 102 resonating structure and a device 104 used within the source's 102 generated wireless field to receive energy from the generated wireless field. The diagram also shows the optimum planar relationship between source 102 and device 104 being parallel (180 degrees) to the face of the antenna elements of each respective component. The diameter of the source 102 (ds) and the diameter of the device 104 (dd) are variable quantities although the device 104 diameter (dd) is a fraction of the diameter of the source 102 diameter (ds) such that the resultant length of the antenna elements within each component resonate. The distance between source 102 and device 104 is a maximum of L. Any multitude of devices 104 may simultaneously be within the field L and simultaneously receive power from the source's 102 generated wireless field. As this system is based on resonant inductive coupling, a wireless energy field is only generated by the source 102 if devices 104 are present within L range. To note, L varies depending on the distance and angle away from the source 102.

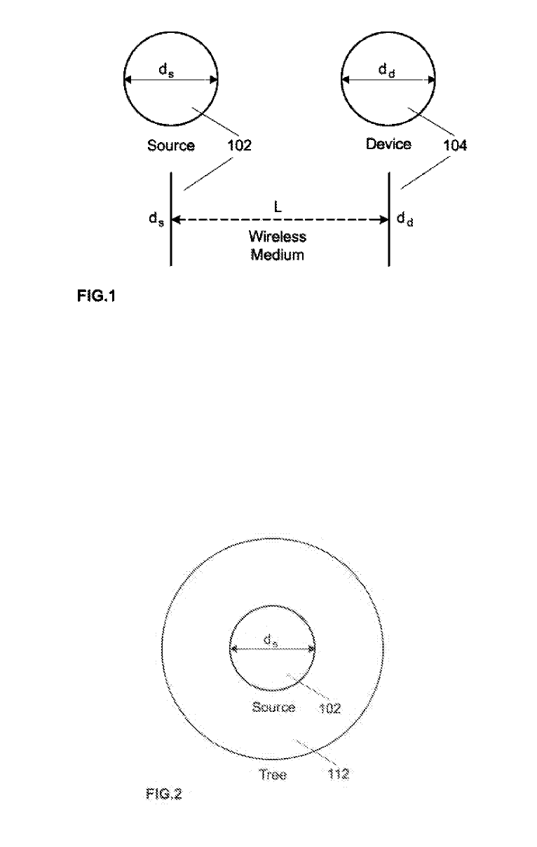

FIG. 2 depicts a schematic diagram illustrating the relative position between the source 102 and a tree 112 taken from an overhead view. This figure shows that the source 102 and tree 112 should be centered around the same origin taking a horizontal slice and viewing from the top of the tree. The source 102 diameter (ds) varies depending on a number of factors taken into account including the diameter of the tree at a given height, resonant frequency of the source 102 resonating structure, and the power required from devices 104.

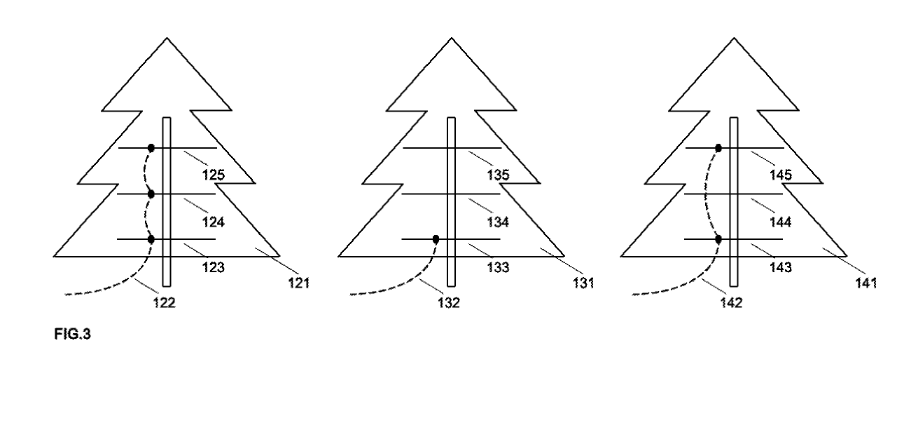

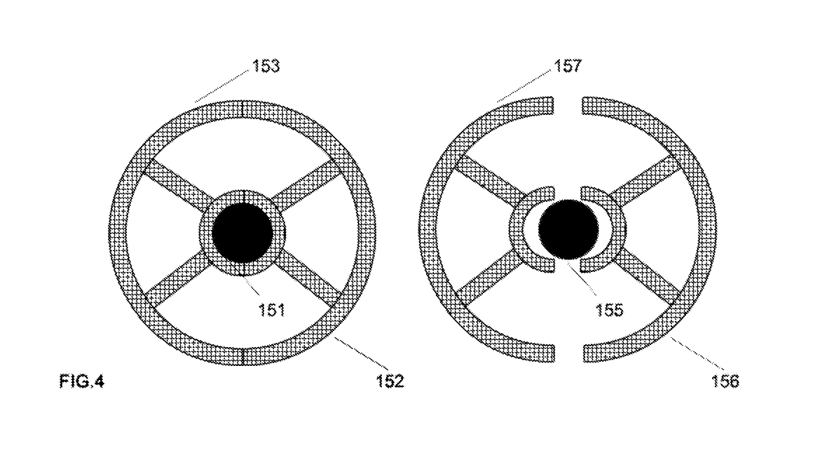

FIG. 3 depicts a schematic diagram demonstrating a variety of representative system configuration options taken from a side view if the trees were sliced vertically down the middle. Given that there are a variety of applicable system options depending on user requirements, a variety of configurations are presented and discussed.

The first tree 121 instance depicts a number of powered source resonant structures here labeled 123, 124, and 125 and connected to a wired power source by the power wire 122. Three source resonant structures 123, 124, 125 are shown here but that number can be minimized from at least 1 to an infinite amount as any number of powered source resonant structures can be included to create individual generated wireless fields and thus cover different portions of the tree providing devices 104 the ability to receive power from an increased number of locations.

The second tree 131 instance depicts a single powered source resonant structure 133 connected to a wired power source by the power wire 132 and several unpowered resonant structures labeled 134 and 135. Two unpowered source resonant structures 134, 135 are shown in FIG. 3, but that number can be minimized from at least 1 to an infinite amount as any number of unpowered source resonant structures can be included to inductively couple to the powered source resonant structure 133 thus extending the range of the source resonant structure 133 while creating individual generated wireless fields around each unpowered source resonant structure 134, 135, and thus to cover different portions of the tree providing devices 104 the ability to receive power from an increased number of locations.

The third tree 141 instance depicts a combination of powered source resonant structures 143, 145 connected to a wired power source by the power wire 142 and a single unpowered resonant structures here labeled 144. One unpowered source resonant structure 144 and two powered resonant structures 143, 145 are shown in FIG. 3, but the configuration, and thus the numbers, of powered and unpowered resonant structures, can fluctuate and also vary in location depending on the end user requirements. The point of adding unpowered resonant structures is to extend the range of the powered resonant structures without the burden of wires. However, in certain situations, powered resonant structures may be periodically added in order to boost the available power extended by the unpowered resonant structures as there may be power degradation when using the unpowered resonant structures. Both the number of powered or unpowered resonant structures can be minimized from at least one to an infinite amount. Any number of powered or unpowered source resonant structures can be included to extend the generated wireless field, and thus cover different portions of the tree providing devices 104 the ability to receive power from an increased number of field locations.

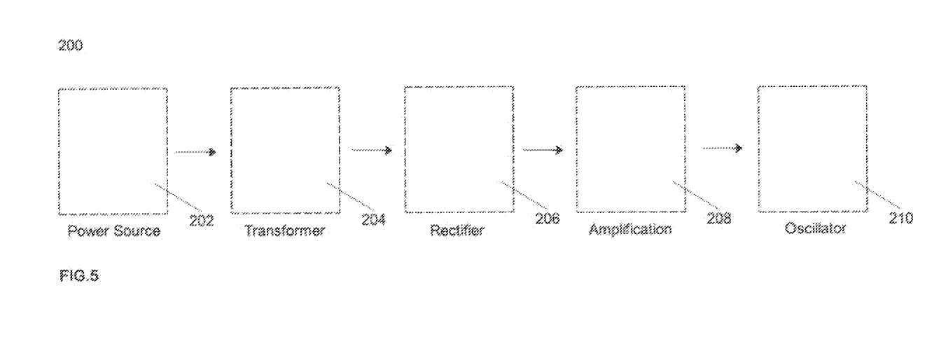

FIG. 4 depicts a schematic diagram demonstrating a representative system of attachment to the tree's trunk 151, 155 taken from an overhead view. As there are several methodologies of connecting the resonant structure to the trunk of a tree, this representative diagram shows that the resonant structures can be separated into left 153, 157 and right 152, 156 segments in order to attach them to the tree's trunk 151, 155. This particular diagram is a representation to show that separating the resonant structure into any number of individual segments for installation is necessary.

### Components

The details pertaining to the wireless Christmas tree providing a non-radiating wireless energy field by means of resonant inductive coupling may comprise the resonant source 102 and the receiving device 104. The configuration and location of the resonant sources, whether powered or not, may comprise the wireless Christmas tree enabling a number of receiving devices 104 to participate within the system, without wasting unnecessary energy, by limiting transmitted energy to those receiving devices 104 with a sufficient antenna resonant with the source 102. Power may be only supplied to a device 104 resonant receiving structure within the source's 102 generated wireless electric field. It is also the combination of powered and unpowered resonant structures as depicted within FIG. 3 that provide a wireless field fully encompassing the individual trees 121, 131, 141.

With reference to FIG. 5, a flow diagram illustrates power flow through components of the system. Specifically for Christmas trees and ornaments, the design provides enough volume within the transmission fields to cover the locations at which the receiving ornaments will be placed. Within this system the receivers must are designed in order to receive and transfer enough power to operate the ornament's powered features. The volume of each of the fields of the transmitters 200 and repeaters 220 are achieved through a combination of factors that include but are not limited to the area the antenna occupies, length and gauge of the wires or tubes, configuration of the wires, polarity of the wires, winding pattern, spacing between wires, voltage asserted on the transmitting antenna, current generated through the transmitting antenna, electronic components used within the design, characteristics of the electronic components used within the design, the location of the transmitters within the tree, and the frequency of the oscillating waveform utilized in the design. Correspondingly the size of the antennas and components may be configured to be hidden in their respective areas—the transmitting antennas and repeaters hidden within the circumference of the tree and the receiving antennas hidden within the body of the ornament or becoming the body of the ornament or structure.

The three main parts within the system may include a transmitter, repeater, and receiver, although a multitude of transmitters 200, repeaters 220, and receivers 240 may be utilized to comprise the system.

Within the following description, LC and Lumped LC circuits are referenced in order to describe the relationship of the inductive (L) and capacitive (C) components of the system. Within the system the inductive components referred to as antennas are wires or tubes that functionally are distributed inductors. Additional inductors and capacitors can also be used in the design as discrete elements added to the circuitry and connected to the antennas in order to modify the resonant frequency of the antenna elements.

### Resonating Source Element

The resonating source element 102 generates a wireless energy field supplying power to receiving devices 104 within its applicable field. Much like a transformer, resonant inductive coupling comprises a source 102 signal created within a primary coil and transferred to a device 104 via its tuned receiving coil, commonly called a secondary coil. This system allows the source element 102 to only transfer power and thus generate a wireless energy field when a device 104 is requesting power by simply being present within the applicable field.

Two embodiments of resonating source elements 102 may include wired and wireless resonant elements 102. A wired resonant source element 102 may be one that is connected to a power source via a wire so the power source stimulates a signal within the resonant element 102 translating to a wireless energy field surrounding the source 102 transmitter. A wireless resonant source element 102 may alternatively be one that is connected to a power source via wireless means much like a device 104. A wireless resonant source element 102 simply extends the range of the wireless field by emitting its own wireless field rather than consuming the energy internally.

In one embodiment, the purpose of the transmitter 200 is to generate a magnetic field in order to transmit energy to receivers within the generated field. The main components of the transmitter include a power source 202, transformer 204, rectifier 206, amplification, and oscillator 210 stages. The process of creating the field is as follows.

The power source 202 for a consumer system may be wall power. This source is fed into a transformer 204, which transforms the wall voltage to a higher voltage. The rectification 206 stage converts the higher voltage A/C signal to a D/C signal (in an alternative embodiment, the D/C stage can be bypassed and A/C signal can be fed directly to the amplification stage 208 with a slightly different design). Coupled to the amplification stage 208, the oscillator stage 210 or LC circuit, which generates the oscillation, is driven into oscillation, and the transmitting coil generates a magnetic field capable of supplying power to the receiving devices. This field is created by the oscillator 210 and operates at a constant frequency. In order to gain the furthest transmission distance from the transmitter at the lowest power, the frequency utilized is the resonant frequency of the transmitter that is generated by the combination of components within the transmitter, namely the capacitance and inductance, which comprise the oscillator. Other components used within this stage and in different configurations provide unappreciable differences in functionality.

Unlike other transmission systems which use a transmission source inductively coupled to the transmitting antenna thereby creating two air-gapped loops, the transmitter described herein uses a single directly connected LC circuit whose antenna is directly attached in order to minimize the effects of external objects that would act to adversely affect the resonant frequency of the transmitter by affecting the LC characteristics of the transmitting stage through mutual coupling and coupled capacitance.

The efficient configuration may provide a resonant frequency while maintaining characteristics within federal guidelines. Also gained through this approach is a system that retains a strict resonant frequency by being much less affected by external objects, which in other systems, would manipulate the fundamental frequency and cause the transmitter, repeater, and receivers to operate on different frequencies and thus fail to operate correctly.

### Receiving Device

The receiving device 104 is shown in FIG. 1 as a single device 104, but may be a plurality of devices, all which operate simultaneously within the system. For example each individual lighting element may be considered as single device 104 for illustration here, but many tens or hundreds of lighting elements can be utilized in a single system. The receiving device 104 consumes the power it receives from the wireless field generated from the source 102 in order to operate. As a normal device utilizing power to operate, the receiving device 104 can consume power provided by the device's 104 receiving element to perform a multitude of functionalities. The device 104 herein is provided power through the wireless field rather than standard power transfer techniques such as wired power, battery power, or a radiating energy field. These receiving devices 104 may include lighting, ornaments, and/or mechanical and electronic items that require power to operate.

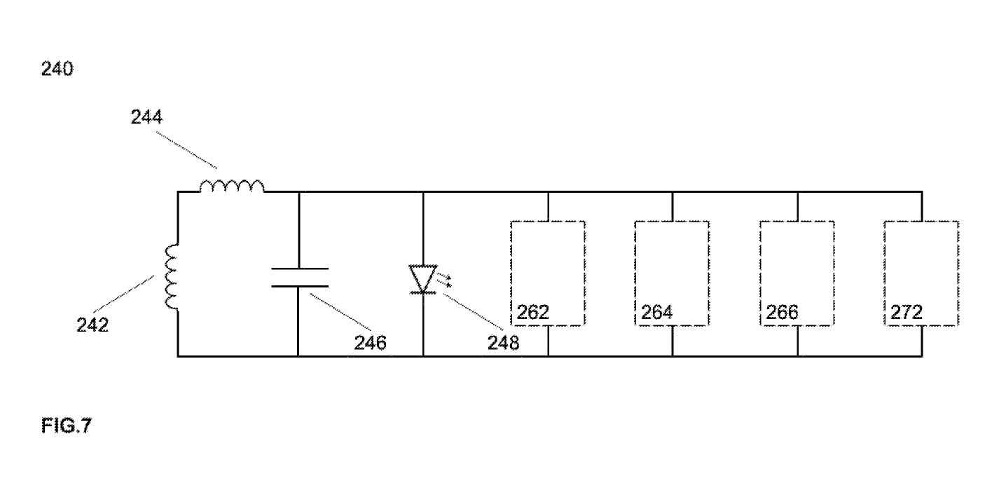

With reference to FIG. 7, a circuit diagram illustrates parts of a receiver that could be used according to one embodiment. There are a variety of receiver 240 options that can function within the system with a number of transmitters 200, a number of repeaters, and multitude of distributed receiver 240 elements. With respect to the Christmas tree example, a number of receivers 240 can be used to transfer power to individual ornaments without the need to be connected using wires. This wireless mechanism for the ornaments to receive power allows the ornaments to perform a variety of functions that require power, such as light up, contain mechanical, sound, computing, other wireless transmission and receiving capabilities, including other functionality which requires power to operate.

The structure of the receivers may be simple and inexpensive to satisfy the consumer marketplace and thus achieve a low cost due to their high volume with respect to the Christmas tree embodiment. The following can be a subset of designs possible to be used as receivers. All receivers described include a coil antenna and additional L and C elements connected to the antenna in order to achieve a consistent resonant frequency with the transmitters 200 and repeaters 220.

In one embodiment, the most basic design for the receiver 240 is an antenna coil 242, possible additional inductor 244 in series, and capacitor 246 element connected in parallel to create an LC circuit. Added in parallel to this is a number of light emitting diodes (LEDs) 248 which are lit using the transferred power. In this manner the LEDs 248 act as diodes to reject the reverse voltage and utilize the forward voltage to power their internal lighting mechanism. If another type of device can utilize an A/C power source, it may also be directly connected in this fashion however consideration must be made as to the voltage limits of the device as well as the impedance that it imparts onto the receiver which may affect the resonant frequency.

Another embodiment for the receiver comprises a more generic receiving element and output circuitry allowing a larger multitude of devices to be connected, as it essentially creates a generic power output which is decoupled from the receiving antenna such that the resonant frequency is unaffected no matter what is added as a load. The receiver antenna 242, L 244, and C 246 components establish the resonant frequency, the decoupling and rectifying stage 262 is built using a combination of components similar to a typical A/C to D/C rectifying stage, including diodes, inductors, and capacitors. Following the rectification stage, a voltage regulation 264 stage possibly using a voltage regulator or Zener diode may be used if voltage regulation is required. At this point a load 266 can be attached to the circuit without affecting the resonant frequency of the receiver.

Alternatively, in order to achieve a balanced and consistent output voltage, another embodiment may include a booster circuit 272 utilized either before or after the rectification stage mentioned previously in order to achieve a constant voltage. Within a wireless power transfer system, the distance from the transmitter affects the voltage seen at the receiving 240 element. A booster circuit 272 would take a wider range of input voltages and boost and regulate that voltage to a single stable voltage at the cost of a higher power consumption but at the benefit of a consistent voltage output.

### Repeater

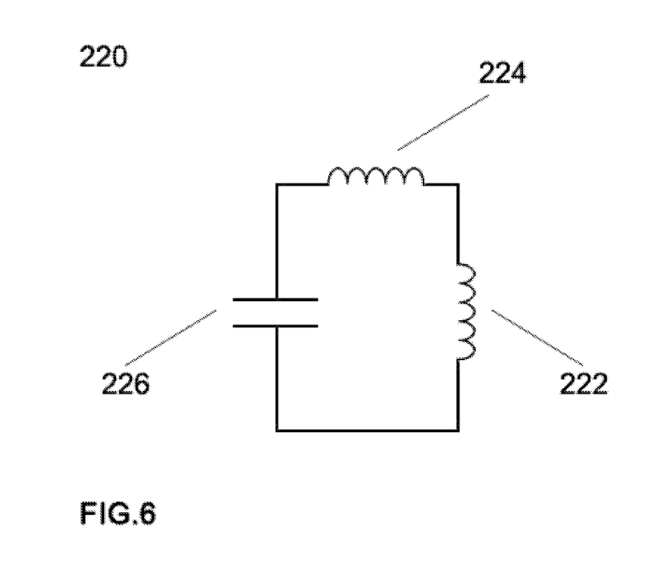

With reference to FIG. 6, a circuit diagram of a repeater that could be used in one embodiment is shown. The purpose of a repeater 220 is to extend the volume of the transmission field by matching the resonant frequency of the transmitters 200 and receivers 240. The repeater is a strictly passive device, not directly connected to any other device but rather simply repeats the signal from transmitter 200 to receiver 240 thus increases the field allowing for a further distance to which the receivers 240 can operate.

The repeater 220 may create an LC circuit matching the resonant frequency of the transmitter 200 and receiver 240 elements. Its design also reflects a lumped circuit design in order to minimize the effects of external objects on the resonant frequency of the repeater 220. The repeater 220 may be built with an antenna and lumped LC circuit by adding inductors 224 and capacitors 226 in order to match the fundamental frequency of its associated transmitter 200 and receiver 240 elements.

### The Tree

Although a Christmas tree is described herein, the system can be applied to other similarly decorated trees and bushes. As trees vary in size, including height, width, and density, the system described herein applies to a variety of sizes and configurations of source elements 102 and can include wired or wireless source 102 resonant structures.

Wired and wireless resonant structures may both be utilized in order to cover the whole surface of the tree 121, 131, 141 with the source 102 generated wireless field. Without full coverage of the tree's 121, 131, 141 surface area, only the portion of the tree 121, 131, 141 that coincided with the generated wireless field would be able to provide power to coupled devices 104. A combination may be used as user situations will vary, requiring a different combination of wired and wireless source 102 resonant structures.

### Additional Features

Additional features can be optionally added to the device and system to create a more unique and user-friendly experience providing advantages in a variety of situations. For example, a remote power control may be used. Remote control of the system can be easily added through wired or wireless mechanisms known to those skilled in the art. The remote control could connect through a network and include an ability to switch the main power supply on and off.

Programming may also be included, whether wired or wireless. A program may allow the system to perform various functions including switching the power supply on and off at certain intervals to create blinking effects.

Alarms may be included. Adding a simple timing element so that the device is switched on and off at various times of the day may enhance operation. The alarms can also be triggered by proximity sensing. For example, the system may be enabled only when people are in the room or when a Bluetooth signal is detected from a phone indicating the presence of an individual in a given location.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for wireless non-radiative energy transfer, comprising:
a transmitter comprising an inductively coupled power source that is configured to provide a magnetic energy field;
one or more receivers that are configured to be placed within the magnetic energy field; and
a decoupling and rectifying stage configured to supply power to a device.

2. The system of claim 1, wherein device is a powered ornament.

3. The system of claim 2, wherein the powered ornament is a light.

4. The system of claim 2, wherein the powered ornament is an electrical feature.

5. The system of claim 1, further comprising a repeater to extend the volume of the magnetic energy field.

6. The system of claim 5, wherein the transmitter, receiver, and repeater each comprises inductive and capacitive components.

7. The system of claim 5, comprising a plurality of repeaters.

8. The system of claim 1, comprising a remote control.

9. The system of claim 1, comprising a timing element.

10. The system of claim 1, wherein the receiver further comprises an antenna coil.

11. The system of claim 1, wherein the transmitter comprises a resonating source element.

12. The system of claim 11, wherein the resonating source element comprising a primary coil.

13. The system of claim 12, wherein the receiver comprises a secondary coil.

14. The system of claim 1, comprising a plurality of transmitters.

15. The system of claim 1, comprising a plurality of receivers.

16. The system of claim 1, comprising a plurality of repeaters, transmitters, and receivers.
